(19) United States
(12) Patent Application Publication
(10) Pub. No.: US 2022/0074690 A1
(43) Pub. Date: Mar. 10, 2022

(54) SYSTEM AND METHODS FOR REMOTE MONITORING OF WEAPONS WITH ALERTS TO ENABLE RAPID AWARENESS OF UNAUTHORIZED EVENTS

(71) Applicant: Belami Christian Lloyd, Surprise, AZ (US)

(72) Inventor: Belami Christian Lloyd, Surprise, AZ (US)

(21) Appl. No.: 17/016,343

(22) Filed: Sep. 9, 2020

(51) Int. Cl. F41A 17/06; H04Q 9/00; H04W 4/38

(52) U.S. Cl. CPC F41A 17/063; G01S 19/42; H04W 4/38; H04Q 9/00

(57) ABSTRACT

A sensor device attached to a weapon or its storage container, having on-board power, a processor and memory, wireless communications circuitry, sensing circuitry, preprogrammed to execute a range of functions at least periodically, configured for sending signals containing values including at least motion changes to a gateway device, which upon detection of certain values, executes programmed functions and provides alerts to the owner of the weapon by defined methods of communication, including utilization of additional condition checking and actions performed by an Internet network connected central server, where information and configuration options are made accessible by interactive interface.

### CROSS-REFERENCE TO RELATED DOCUMENTS

The present invention is a Non-Provisional application of U.S. Provisional application 62/897,895, filed on Sep. 9, 2019. The disclosure of priority application is incorporated herein at least by reference.

### FIELD OF THE INVENTION

The present invention relates to systems, methods and apparatuses for monitoring firearms, other weapons, and weapon storage containers by utilizing low power long range wireless sensors, networks, computing systems and alert services to immediately notify persons, trigger alarm systems and services, and/or contact law enforcement when unauthorized weapon handling or tampering occurs.

### BACKGROUND OF THE INVENTION

In the United States, the number of firearms alone exceeds the population. When also including other weapons such as bows, crossbows, swords or others, the number of weapons is significantly increased. Unfortunately, far too many weapons are improperly stored and are easily accessible without their owner being aware of any unauthorized activities. When a weapon is stolen during a burglary or moved or handled by a family member, employee or other person(s) without authorization, the owner of the weapon is typically not aware and cannot react until it is too late.

There are many reasons for improper storage of weapons among weapon owners. These may include the inability to afford the cost of locks, storage containers, or perhaps a lack of space, or accessibility, or any number of numerous other reasons. Regardless of which reasons apply, the problem is clear. Too many weapons are accessible without any owner awareness, and this fact presents a danger on a daily basis.

Neither legislation changes nor law enforcement can reasonably address issues with stored weapons. The most effective solution is to empower the weapon owner with rapid awareness of an unauthorized activity, because the weapon owner is likely to know how to best react to such activity. However, while the technology to address these issues exists, a practical system which utilizes the available technology to provide the solutions does not exist.

There is a need for a complete, cost-effective and easy to use system that enables weapon owners to easily add a motion detecting tracking device to virtually all of their new and existing individual weapons or storage containers without being limited by weapon attachment options and/or a particular home alarm system. In fact, many would benefit from a system that is not only flexible in sensor attachment options, but also one that can integrate with new or existing alarm systems, and even be used as a portable system for activities such as camping or hunting trips where weapons are even more portable and in many cases, less protected.

### SUMMARY OF THE INVENTION

The problems stated above with regards to the issues of unknown activities involving stored weapons, the lack of ability to monitor multiple various weapons, limitations to tracking a particular type of weapon, and the current lack of practical solutions to help address these problems prompted the inventor to develop a solution. A solution that would effectively monitor any weapon, notify of any motion that occurred outside of normal conditions, and be easy to use and cost effective.

The present invention solves many problems with one flexible and modular system that utilizes a base station that functions similarly to how a typical wireless router would, and the 1-N number of sensor devices broadcasting sensory and other data in timed intervals, which the base station receives and processes, then quickly notifies the owner with alerts. Optionally, the base station also forwards data to a cloud-based service for more control and processing.

Taking into account the reasonable requirements of cost, flexibility, and reliability, the inventor worked to develop a solution that encompassed these requirements. In addition, the system was designed to function both independently and/or as an extension of existing systems.

What began as a simple sensor idea grew into deep thought and consideration of numerous conditions. Many “what if” situations were pondered, each requiring further problem solving to develop a viable solution. For example, the size of the sensor device had to be small, the communications methods had to exceed typical Bluetooth and WiFi range and penetration by using Long Range Wide Area Network technology, the battery should power sensor for many months before needing to be recharged, battery life and charge should be monitored, there should be many mounting options for various weapons and storage containers, enclosures should be water proof and should provide impact resistance, GPS coordinates should be optional, sensory data should be useful and transmitted with minimal packet sizes requiring special formatting, devices should be very easy to implement and manage and so on.

BRIEF DESCRIPTION OF THE DRAWING FIGURES

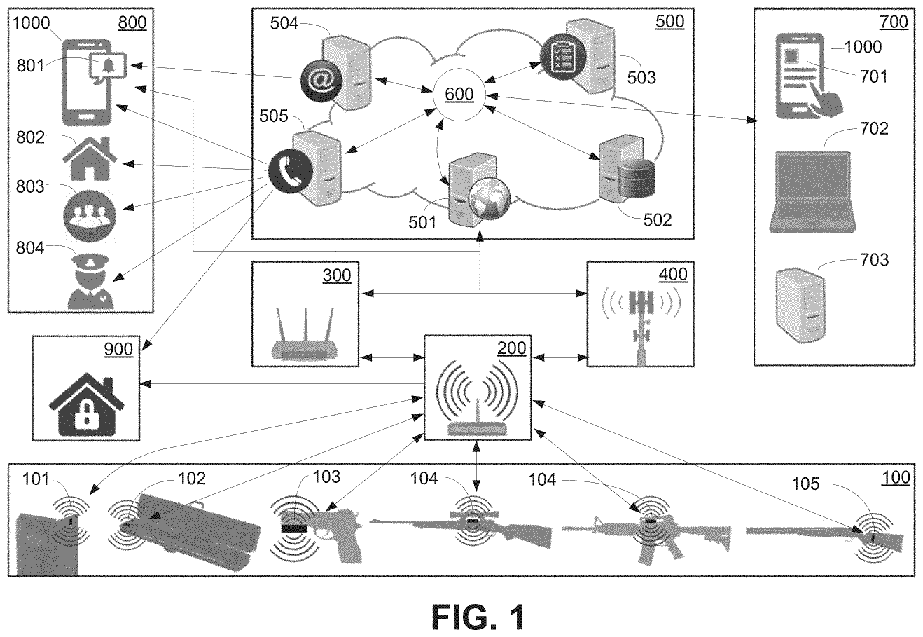

FIG. 1 is a block diagram depicting exemplary relationship and order of processing in an exemplary system in accordance with some embodiments of the invention;

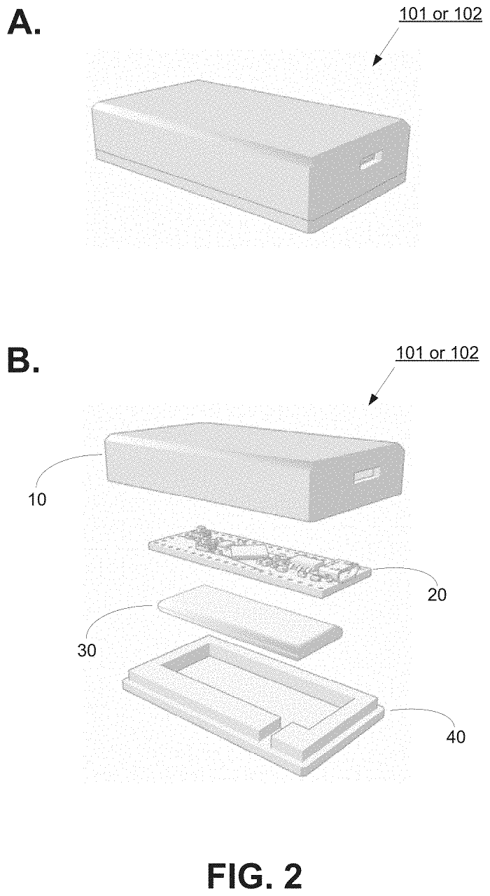

FIG. 2 shows views of an exemplary surface mount sensor device and components in accordance with some embodiments of the invention;

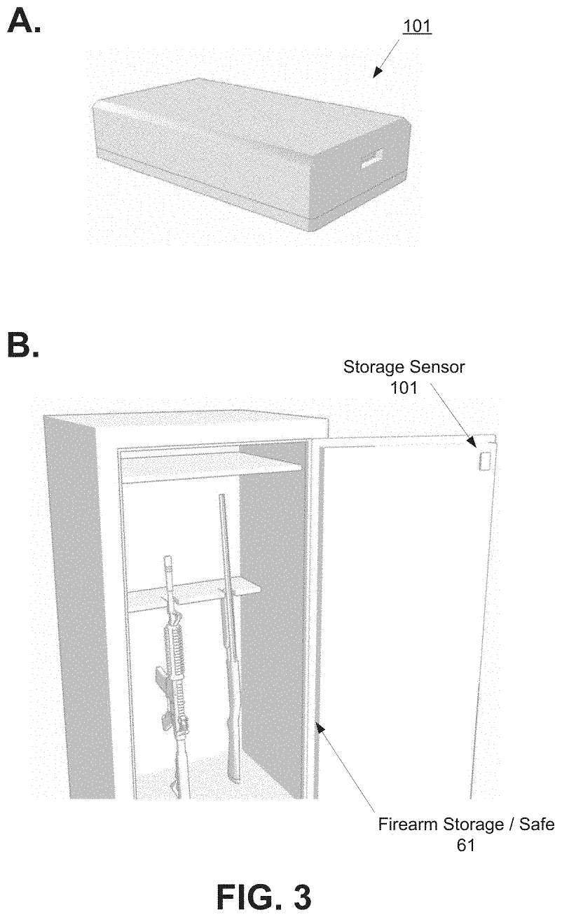

FIG. 3 shows views of an exemplary storage safe sensor device in accordance with some embodiments of the invention;

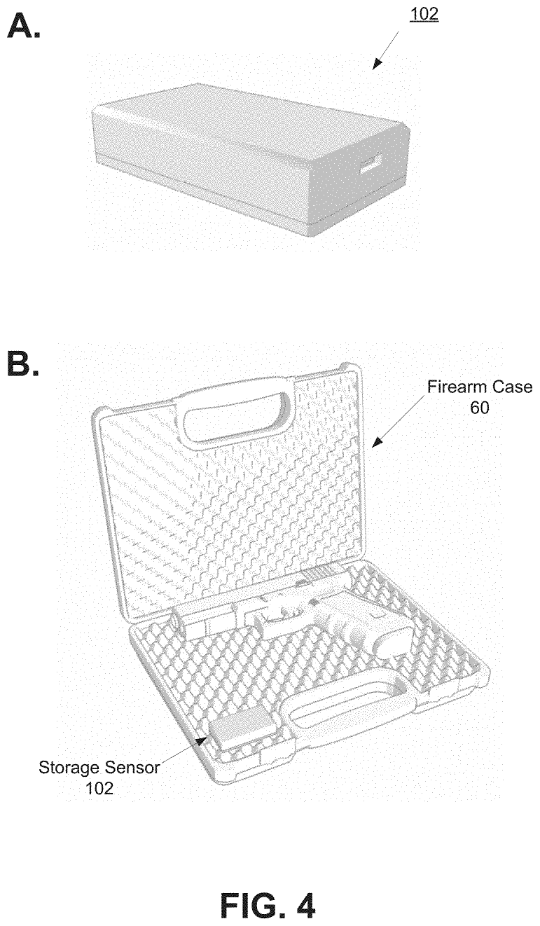

FIG. 4 shows views of an exemplary storage container sensor device in accordance with some embodiments of the invention;

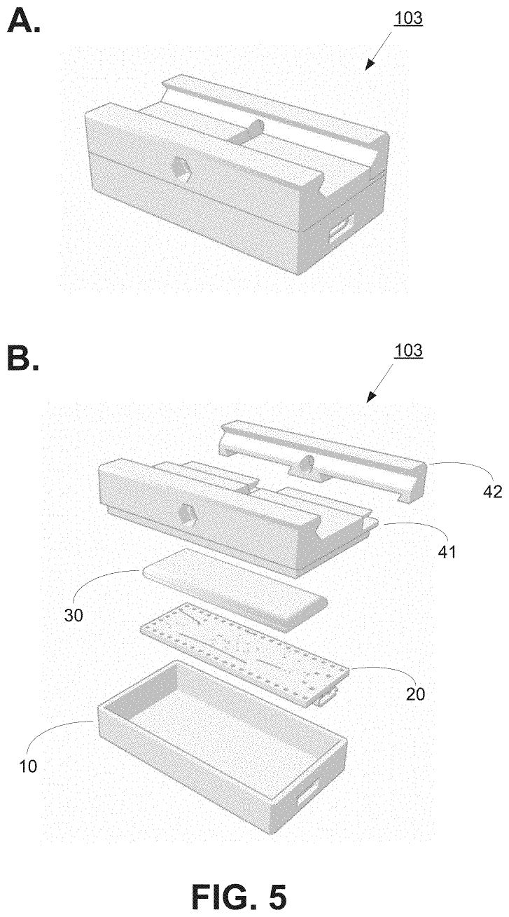

FIG. 5 shows views of an exemplary handgun rail mount sensor device in accordance with some embodiments of the invention;

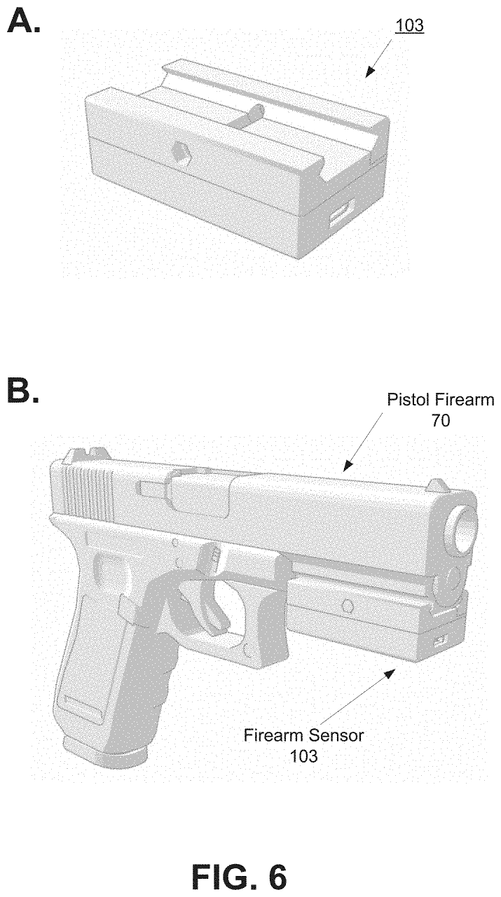

FIG. 6 shows views of an exemplary handgun rail mounted sensor device in accordance with some embodiments of the invention;

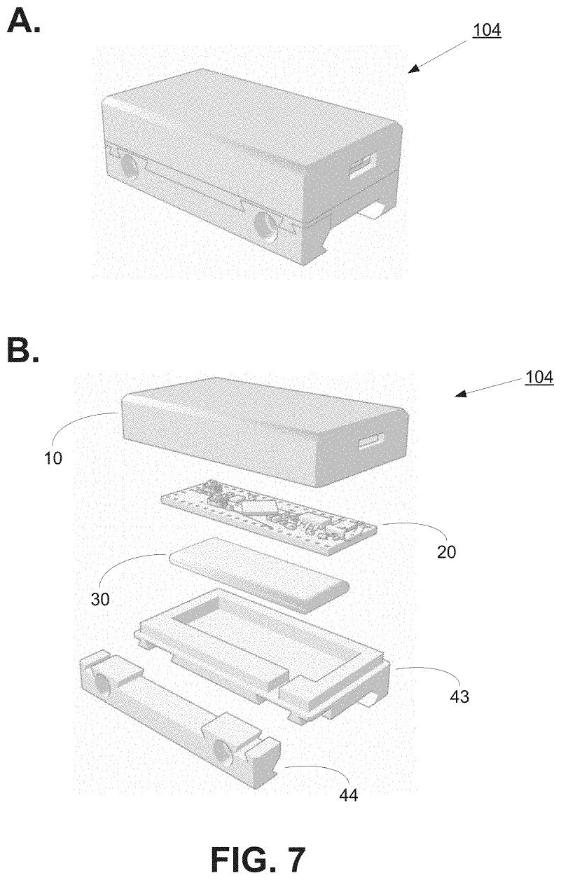

FIG. 7 shows views of an exemplary rifle rail mount sensor device in accordance with some embodiments of the invention;

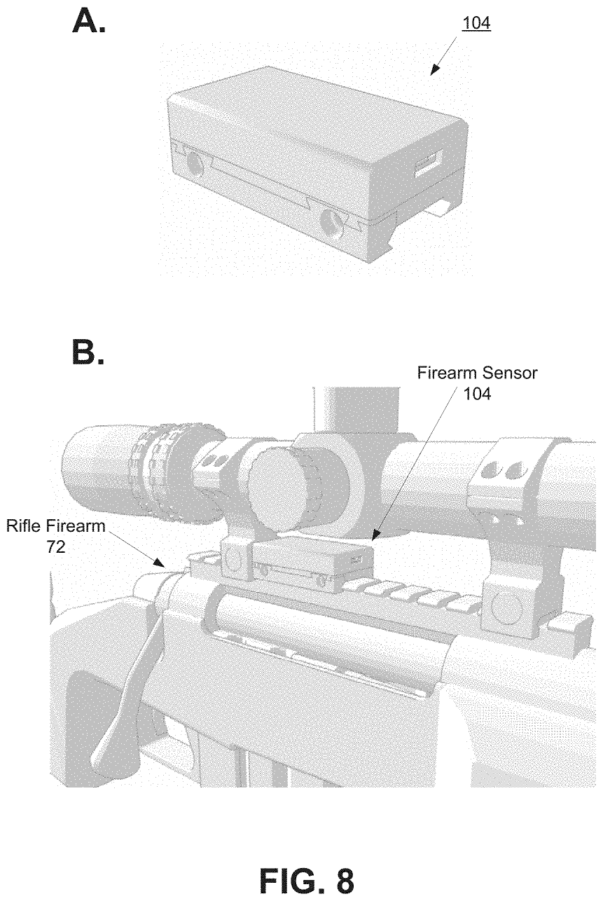

FIG. 8 shows views of an exemplary rifle rail mounted sensor device in accordance with some embodiments of the invention;

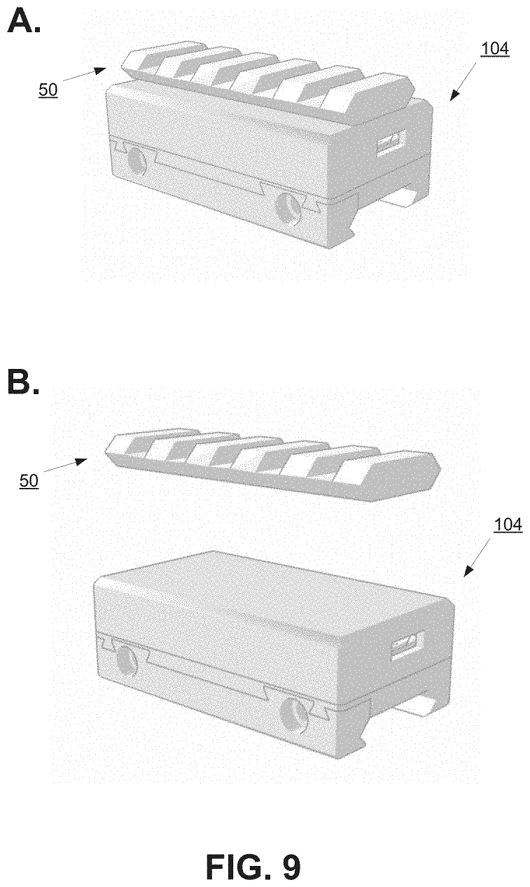

FIG. 9 shows views of an exemplary rifle rail mounted sensor device with rail attachment in accordance with some embodiments of the invention;

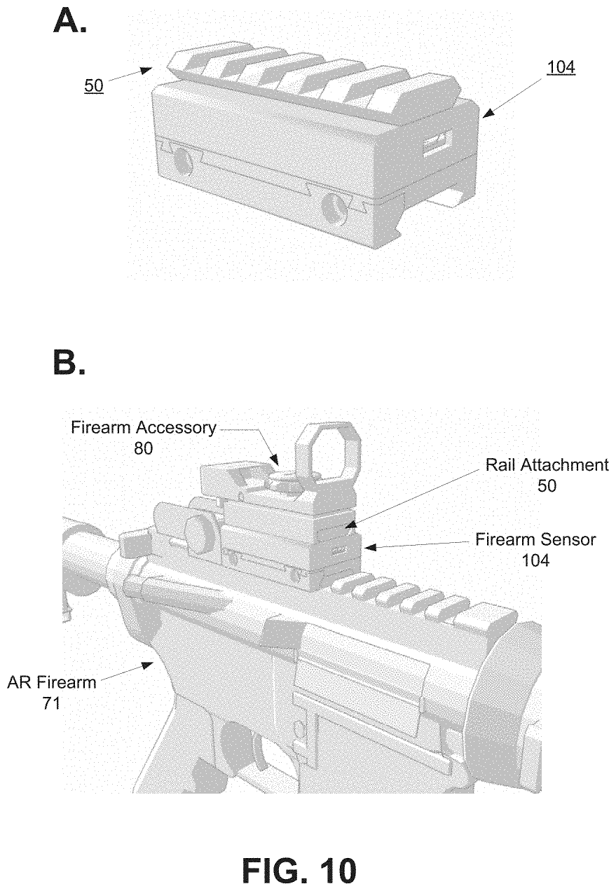

FIG. 10 shows views of an exemplary rifle rail mounted sensor device with rail attachment supporting an accessory in accordance with some embodiments of the invention;

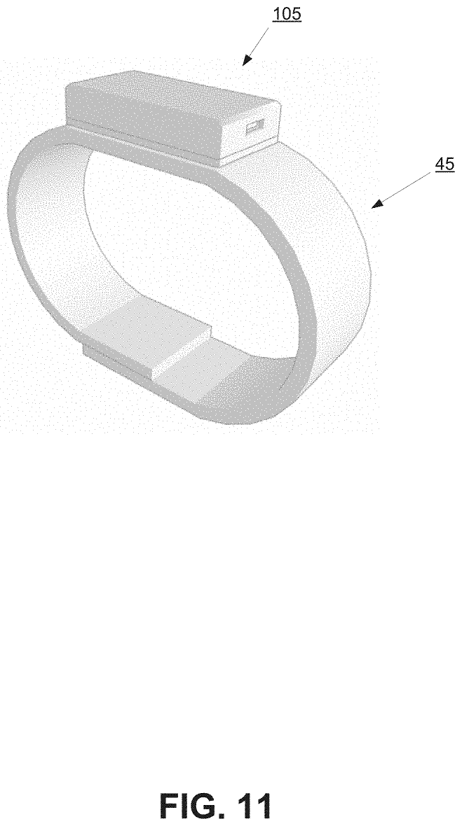

FIG. 11 shows views of an exemplary strap mount sensor device in accordance with some embodiments of the invention;

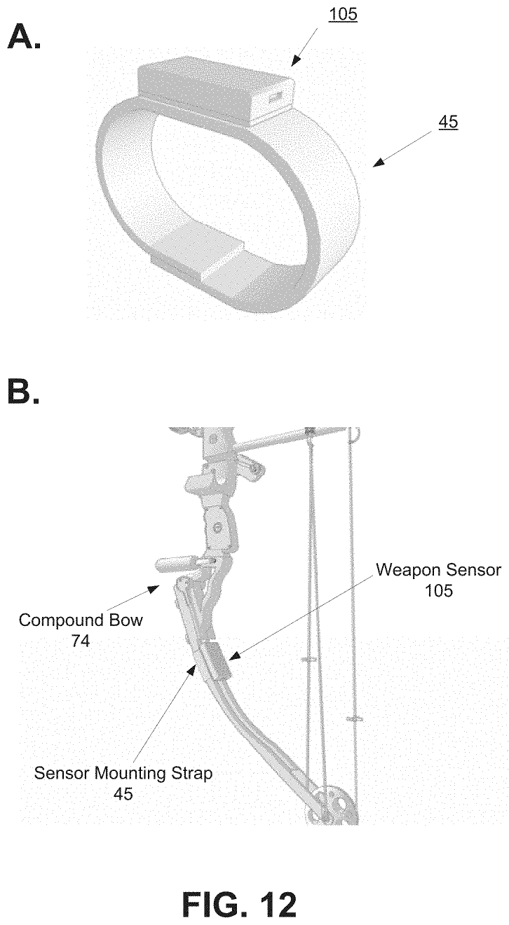

FIG. 12 shows views of an exemplary strap mounted sensor device in accordance with some embodiments of the invention;

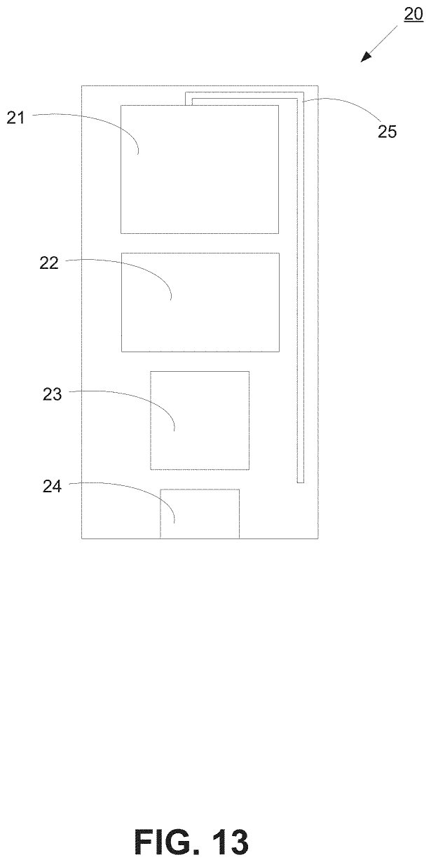

FIG. 13 shows a block diagram of components within an exemplary sensor device in accordance with some embodiments of the invention;

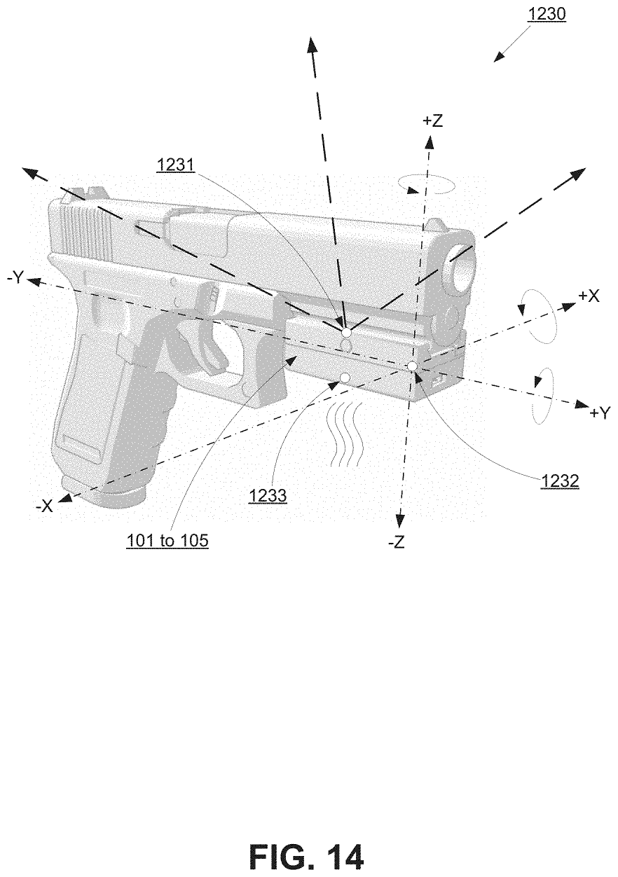

FIG. 14 shows a diagram of multiple sensory capabilities within an exemplary sensor device in accordance with some embodiments of the invention;

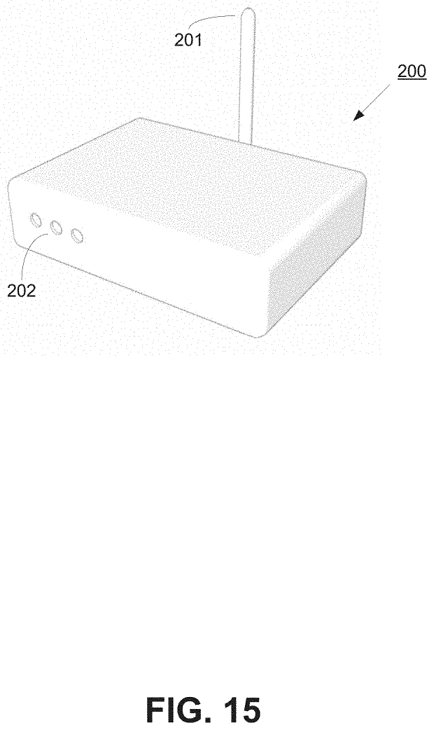

FIG. 15 shows a view of an exemplary base station device in accordance with some embodiments of the invention;

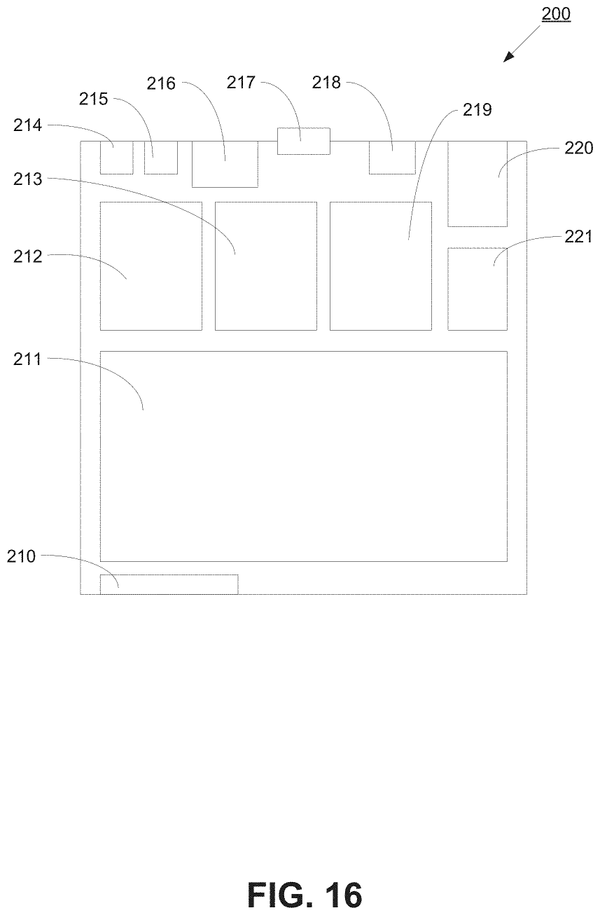

FIG. 16 shows a block diagram of components within an exemplary base station device in accordance with some embodiments of the invention;

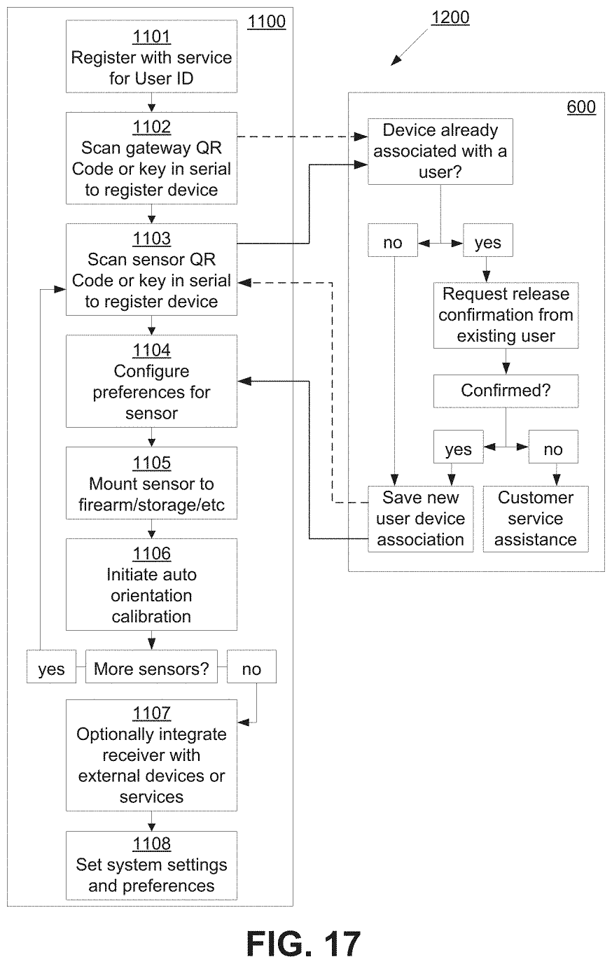

FIG. 17 is a flow chart depicting exemplary device activation methods in accordance with some embodiments of the invention;

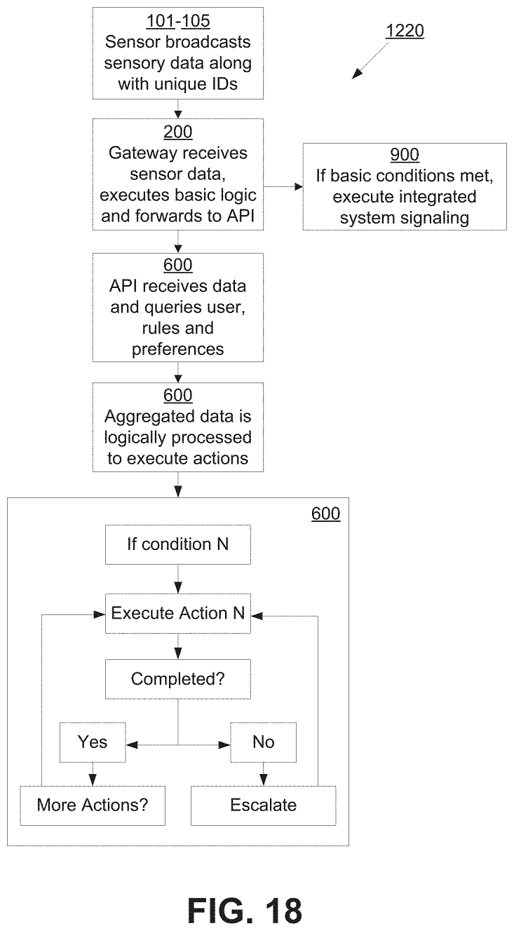

FIG. 18 is a flow chart depicting exemplary system alert methods in accordance with some embodiments of the invention;

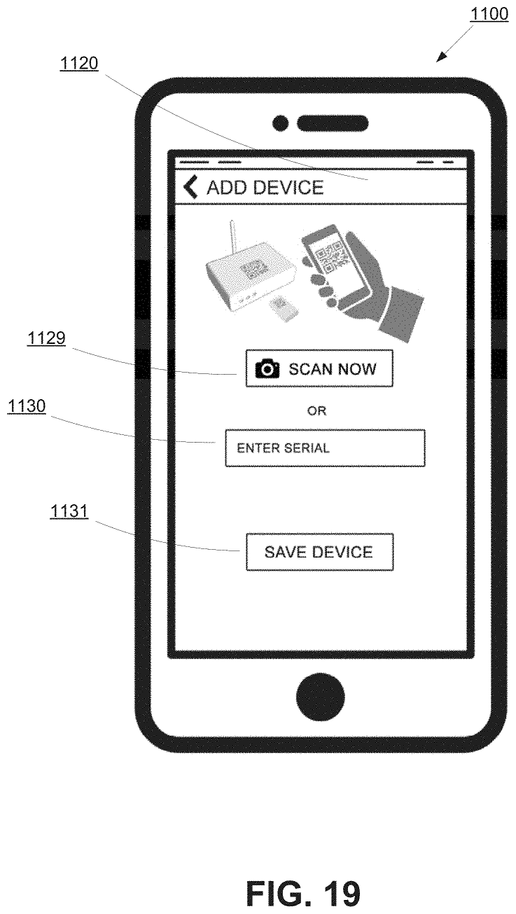

FIG. 19 shows a view of an exemplary mobile user interface for use in device activation in accordance with some embodiments of the invention;

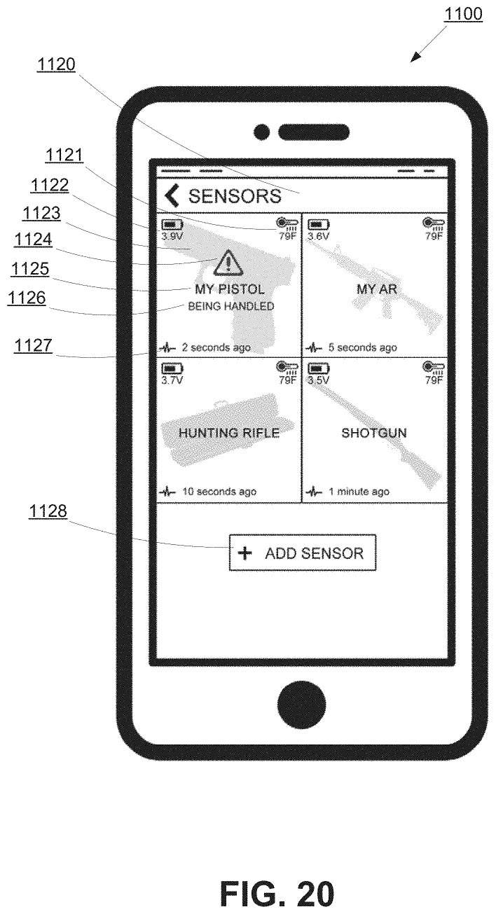

FIG. 20 shows a view of an exemplary mobile user interface used to view status of active sensors in accordance with some embodiments of the invention;

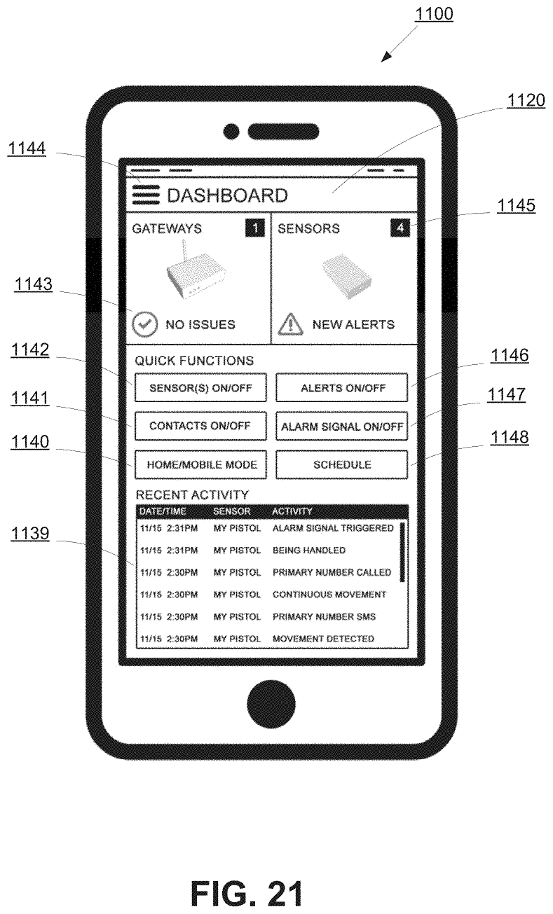

FIG. 21 shows a view of an exemplary mobile user interface used to view overall system status and manage exemplary conditional features in accordance with some embodiments of the invention;

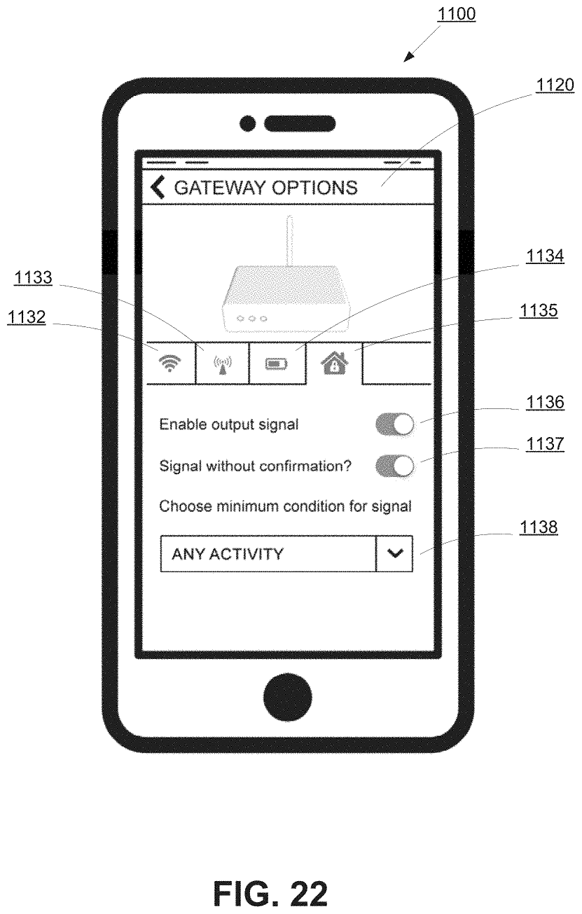

FIG. 22 shows a view of an exemplary mobile user interface used to manage exemplary conditional gateway features in accordance with some embodiments of the invention;

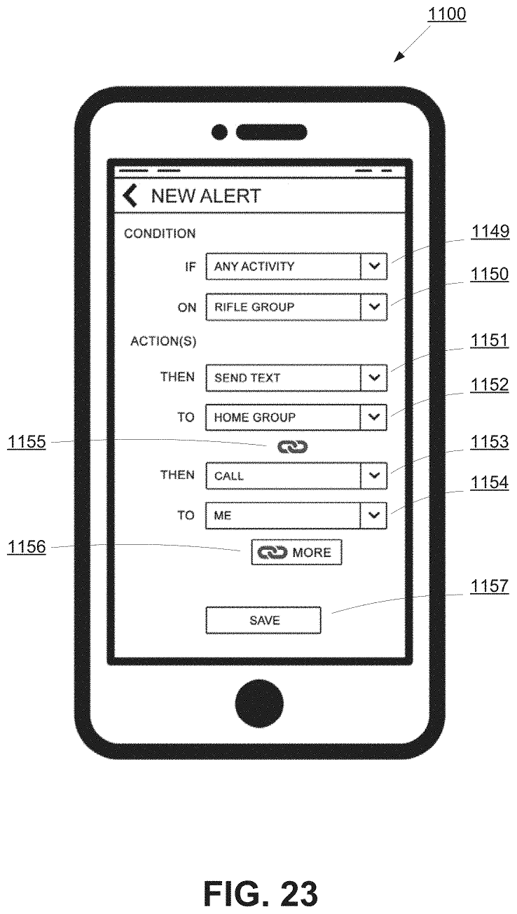

FIG. 23 shows a view of an exemplary mobile user interface used to manage exemplary system condition and alert features in accordance with some embodiments of the invention;

### DETAILED DESCRIPTION OF THE INVENTION

Disclosed herein are systems, methods, devices/apparatuses for implementing and using a weapon monitoring device hereafter referred to as a sensing or sensor device. Embodiments of the present invention provides for attaching a sensing device to a weapon, safe, storage container or other items or enclosures. In certain embodiments, the sensing device contains various internal sensors, a re-chargeable battery, circuitry, logical processing, and communications components to detect, measure and broadcast collected data in programmed and/or timed intervals.

Disclosed herein are systems, methods, devices/apparatuses for implementing and using sensing devices in various forms of enclosures. In certain embodiments, enclosures fulfill mounting needs for various applications. For example, an enclosure would be optimized for mounting onto smooth surfaces with either adhesives or magnetics or Velcro, while another enclosure would be optimized for mounting onto a firearm rail, and another enclosure optimized to mount on a larger range of weapons by utilizing a strap. Enclosure and application examples mentioned herein do not limit the possibilities of types of mounts, enclosures or applications. For example, a sensing device could be integrated into the design of an ammunition magazine, or directly integrated into a weapon design.

Disclosed herein are systems, methods, devices/apparatuses for implementing and using a data collection and processing device hereafter referred to as a gateway or hub. In certain embodiments, the gateway receives data which is broadcasted by sensing devices and compares sensory values to defined conditions to determine whether any actions should be performed locally, complete actions, and optionally forward the data to a private and secure cloud based service for additional processing. The gateway as defined within this application is designed to be a part of the system, but in certain applications, a different device, such as a cellular phone could also perform some of the same functions as the gateway hub device.

Disclosed herein are systems, methods, devices/apparatuses for implementing and using a data collection and processing system hereafter referred to as the cloud service. In certain embodiments of the present invention the cloud service receives data forwarded by gateways, analyzes the data, associates data to accounts based on device serial or ID, and performs actions based on incoming data type and values contained within.

Disclosed herein are systems, methods, devices/apparatuses for implementing and using a software application and user interface hereafter referred to as the user interface. In certain embodiments of the present invention the user interface, whether a web-based application, computer software and/or a mobile application enables users to sign up, add/remove sensing and gateway devices, manage conditions, contacts, services, alerts and notifications, integrations, authorizations and any service billing.

As used herein, a “weapon” refers to, but is not limited to: firearms such as handguns, rifles, shotguns, or other types of objects such as a bow, sword, spear, or others.

As used herein, a “storage container” refers to, but is not limited to: safes, gun cases, rifle cases, bags, boxes or any other type of object which is used to hold or contain a weapon.

As used herein, a “firearm accessory” refers to, but is not limited to: sights, lights, lasers, or other accessories which are designed to mount to a firearm's rail or other attachment system which follows standards such as Picatinny, Weaver or others.

The purpose of any illustrations, diagrams, and drawings are exemplary to describe certain versions of the present invention and are not intended to limit the scope, abilities or capabilities of the present invention's devices/apparatuses, systems, and methods.

The present invention is a system with methods of monitoring weapons using various sensing devices that in some embodiments can directly trigger a local alarm system using matched signaling, or in typical embodiments to broadcast status messages using an onboard long range wireless transceiver radio in timed intervals or as events occur. These broadcasted messages are received by a gateway device which performs basic analysis of the values contained in the message to determine if any local actions should be performed, such as sending a message or triggering a local alarm system, and optionally forwarding data to a cloud service for processing additional rules, conditions, actions and triggers.

Messages broadcasted by sensing devices may include various types of information, including but not limited to: the device identification number, encryption related information, battery level, temperature, x/y/z position, velocity, direction, elevation and optionally GPS coordinates.

With the use of certain communication methods and protocols, broadcasted messages can also be received by other public and private gateways that are within range, which may not be owned by the sensor owner, and the messages can still be received by the cloud service as messages are forwarded to intended recipient by design, which in this case would be the cloud service. This forwarding to the intended recipient is available due to the design of protocol and certain data that is contained in broadcasted messages which identify a recipient. This expands the possibility of messages being received even if the owner's own gateway is not active or within range.

Since other gateways can also receive and forward messages, a general position of a weapon can be determined in the same way a cellular phone can be triangulated, even if the sensing device is not equipped with GPS. It is worth noting that sensing devices do not contain any personally identifiable information, so there are no privacy consequences. It is also worth noting that due to the protocols, gateways, broadcasted messages, and forwarding, the recipient can determine the location of the forwarding gateway, since most public, private and even the gateway hub owned by the weapon owner, typically (by design and common practice) provide GPS coordinates of the gateway itself, and even if that is not the case, the IP address of the gateway can also provide a general location of the gateway. This means that when the cloud service receives a message from a sensing device on a weapon, in certain cases the cloud service can compute and determine if, for example: is the weapon in an area that is defined as a no-gun zone or is it near an airport, school or other official building. Where appropriate, the cloud service can notify the sending gateway or the gateway owner of potential violations as a public safety service. The cloud service would also, to a certain extent, be able to identify the type of weapon and also determine if the weapon is in possession of the owner or not.

FIG. 1 is a block diagram depicting exemplary relationship and order of processing in an exemplary system in accordance with some embodiments of the invention. 100 represents various application optimized sensing devices 101-105 which are attached to different types of weapon and storage objects. 200 represents a gateway device which receives status messages from 1-N sensing devices and can perform actions locally and forward received messages to the cloud service 500 by means of HTTPS traffic over either an internet connected router 300 or on-board cellular radio connected to a cellular network 400. The cloud service, comprised of a web server 501 which receives messages over HTTPS, requests and interacts with various API's (Application Programming Interface) 600 to execute function calls and perform actions such as device association, accounting, changing settings, sending or receiving updates, triggering alerts and other system processing functions and services.

The cloud service API interacts with other devices and services in the cloud, such as a database server 502 which stores system, user and device data, a settings service 503 which handles Get and Set requests to set, update, or delete settings, an email server 504 which sends system and alert emails, and a communications service 505 which handles the sending of communications such as SMS (Text Messages) or placing calls to designated phone numbers (cell phone 801, home phone 802, group of people 803, emergency services 804 and/or home alarm system or service 900). Calls can be configured by user to deliver dynamic messages using Text to Speech if desired, which would include variables such as device name, motion description, and other helpful values. An example message template could be: “Alert: $device_name is $motion_description” which, after processing, would be for example: “Alert: Handgun is currently being handled” or another example could be: “Alert: Handgun is currently located 5.3 miles from hub, click here to view on a map” which would contain a link to maps with the device marker applied at the latest coordinates.

Users can utilize multiple devices 700 to manage their devices, account, and settings. Devices include a mobile device 701 running a mobile app 1000, a laptop or desktop 702 running either a browser or installed software, or an authorized third party service or application 703 using authenticated API service calls.

FIG. 2 Shows views of an exemplary sensing device in a form that is optimized for adhesive or magnetic backing applications (101 or 102), where the device is assembled on view 2A, and 2B showing an exploded view where 10 is the top cover, 20 is the logic board containing all electronic components, 30 is the re-chargeable battery, and 40 is the base of the sensor enclosure.

FIG. 3 Shows views of an exemplary sensing device 101, where the device is attached to a storage container 61 shown on 3B using either a magnetic or adhesive backing. In this example application, the sensing device would detect any motion of the storage container.

FIG. 4 Shows views of an exemplary sensing device 102, where the device is attached to a storage object 60 shown on 4B using either a magnetic or adhesive or other backing. In this example application, the sensing device would detect any motion of the storage container.

FIG. 5 Shows views of an exemplary sensing device 103, where the device is optimized for a shorter firearm mounting rail. 5A presents the device in an upside down assembled perspective view, and 5B shows an exploded perspective view, where 10 is the top cover, 20 is the logic board containing all electronic components, 30 is the re-chargeable battery, 41 is the base mount which is combined with side mount 42 to tighten on to firearm rail with a single bolt and nut.

FIG. 6 Shows views of an exemplary sensing device 103, where the device is assembled on 6A, and mounted onto a small rail of a pistol firearm 70 on 6B using a single mounting bolt and nut. FIG. 7 Shows views of an exemplary sensing device 104, where the device is optimized for a longer firearm mounting rail. 7A presents the device in an assembled perspective view, and 7B shows an exploded perspective view, where 10 is the top cover, 20 is the logic board containing all electronic components, 30 is the re-chargeable battery, 43 is the base mount which is combined with side mount 42 to tighten on to firearm rail with two mounting bolts and nuts. FIG. 8 Shows views of an exemplary sensing device 104, where the device is assembled on 8A, and mounted onto a longer rail of a rifle firearm 72 on 8B using two mounting bolts and nuts.

FIG. 9 Shows views of an exemplary sensing device 104, where the device is assembled on 9A with a short accessory rail 50 mounted on the sensing device's top cover. 9B shows the same device 104 with the accessory rail 50 detached.

FIG. 10 Shows views of an exemplary sensing device 104, where the device is assembled on 10A with a short accessory rail 50 mounted on the sensing device's top cover. 10B shows the sensing device 104 mounted onto the rail of an AR firearm 71, with a firearm accessory 80 mounted on top of the sensing device 104 using the rail attachment 50, enabling the owner to occupy a single space on the firearm for both the sensing device 104 and a firearm accessory 80.

FIG. 11 Shows a view of an exemplary sensing device 105, where the device is optimized for a mounting strap 45, which would enable weapon owners to attach the sensing device to a larger variety of weapons which may not have mounting rails, or where quick and easy attachment or detachment is desired. The strap 45 would be composed of a high strength flexible material and be enclosed with either Velcro or a locking mechanism such as a buckle.

FIG. 12 Shows views of an exemplary sensing device 105, where the device is assembled on 12A, and 12B shows the device mounted onto the bottom limb of a compound bow 74 using the mounting strap 45. The flexibility of the strap mount application allows for numerous mounting options on various weapons. FIG. 13 Shows a block diagram of an exemplary sensing device logic board containing electronic components presented in sections, such as: one or more types of communications radios to enable long range wireless communication in section 21 with onboard integrated antenna 25, various sensing components (i.e. for axes, temperature, direction, speed, co-ordinates and others) in section 22, microprocessor, memory, clock and other base components in section 23, charging/data port in section 24. In some embodiments, the logic board may also contain other features such as: NFC (Near Field Communication) components to allow for wireless local control functions, inductive charging components to provide wireless charging in applications where a full seal water-proofing is required, and a GPS module to provide accurate positioning which could assist in cases of theft.

FIG. 14 Shows an exemplary view to illustrate some core sensing capabilities of various sensing devices 101-105. 1231 represents a 3 axis accelerometer, 1232 represents a 3 axis gyroscope, and 1233 represents a thermometer. With the combination of 1231 and 1232, sensing devices can monitor, record, and process various measurements such as: pitch, yaw, roll, and acceleration, enabling reporting of precise motion activity, and in some embodiments and system implements, controlling a user selected 3D model representing the weapon within a user client to illustrate movements in near real-time, enabling the owner to view actual movements and orientation of their weapons.

FIG. 15 Shows a view of an exemplary gateway hub device enclosure 202, with 201 as an external antenna, and 202 representing visual aid LED lights which indicate status of power status, sensor detection status, and internet connectivity status.

FIG. 16 Shows a block diagram of an exemplary gateway hub device logic board 200 containing electronic components presented in sections, such as: LED status lighting section 21, rechargeable backup and mobile mode battery in section 211, local communications radios/controllers for Ethernet, WiFi, Bluetooth in section 212, GPS radio in section 213, GSM cellular radio in section 219, power plug, power supply, power switch and charging components in section 220, microprocessor, memory and other components in section 221, cellular SIM card port in section 218, TX/RX antenna in section 217, Ethernet port in section 216, external systems signaling output wire connection port in section 215, and external systems signaling input wire connection port in section 214.

FIG. 17 is a block diagram depicting exemplary relationship and order of processing in an exemplary system in accordance with some embodiments of the invention. 1200 represents logical process flow for a device registration, activation and deactivation system for both sensing and gateway hub devices. The processing and flow within 600 occurs in system cloud service. The process and flow within 1100 occurs with user and devices. The process begins with 1101 where the owner is advised to download a free mobile application. The application allows the owner to quickly register and create an account on the system as an owner. Upon registration, the user account is created and the owner is automatically signed into the system on the mobile app. Device registration begins with 1102, where the owner is suggested to take a photo of the QR code on the gateway hub device or key in its serial number. On submit, the data is transmitted to the cloud service 600 to be processed. Upon processing in the cloud service and the device is associated with the owner, the owner can scan sensing devices in 1103 and repeat the process until devices are registered. After registrations are completed, the owner can configure preferences for the individual sensor devices in the mobile app on 1104, mount the sensors to the owner's weapons 1105, initiate orientation of the sensing devices to ensure correct direction is observed by the system so that the correct orientation is included in alerts and such when the weapon motion is reported 1106. The owner can optionally integrate external systems, devices or services with the gateway hub using the in/out ports on the gateway hub 1107. Lastly the owner is able to set and configure system settings and preferences using the mobile app 1108.

FIG. 18 is a block diagram depicting exemplary relationship and order of processing in an exemplary system in accordance with some embodiments of the invention. 1220 represents logical process flow between sensing devices 101-105, gateway hub 200, cloud service 600 and external system signaling 900.

FIG. 19 Shows an exemplary view to illustrate a screen within the mobile app 1100 on a personal smart phone. The exemplary screen used to register a device contains application top 1120 which indicates the active screen and basic navigation, a button 1129 to initialize the device's camera application to scan a device QR code, a text field 1130 to type in device serial instead of QR code scanning, and a “Save Device” button 1131 which upon tapping, transmits the device serial, user id, and other related data to the cloud service for registration.

FIG. 20 Shows an exemplary view to illustrate a screen within the mobile app 1100 on a personal smart phone. The exemplary screen used to monitor sensors contains application top 1120 which indicates the active screen and basic navigation, a variable number of boxes representing registered sensors, each displaying their own data points, including: temperature indicator 1121, sensing device battery level indicator 1122, a user defined background 1123 containing a generic graphical representation of monitored weapon or type, or an actual photo of the weapon taken by owner, or a 3D model of the weapon or type (if found in cloud service model database), an alert icon 1124 when motion is reported by sensing device, a user defined name 1125 for the weapon, a status message 1126 to display a message of activity or notice, a last update time message 1127 to indicate how long ago an activity was reported, and a button 1128 to navigate to device registration screen to add a new sensing device.

FIG. 21 Shows an exemplary view to illustrate a screen within the mobile app 1100 on a personal smart phone. The exemplary screen is a “Dashboard” type screen which is the default when opening the application and contains application top 1120 which indicates the active screen and basic navigation with a Menu icon 1144 used to open the main application menu, boxes 1143 presenting gateway hub and sensor information such as: number of registered devices 1145 and a status message indicating whether or not there are any issues with, for example: battery, connectivity, etc., a section of “Quick Functions” buttons to allow owner to quickly manage certain capabilities, such as: sensor on/off 1142 used to enable or disable reporting, contacts on/off 1143 to enable or disable alerts to certain contacts, a mode status button 1140 to define home or mobile mode allowing the owner to change gateway power and processing features, an alerts on/off button 1146 to allow owner to continue monitoring but not trigger alerts to contacts, an alarm signal on/off button 1147 used to enable or disable external system signaling, a scheduling button 1148 to enter a screen to define days and times where certain features are enabled or disabled, and a “Recent Activity” log table presenting most recent activities across all devices.

FIG. 22 Shows an exemplary view to illustrate a screen within the mobile app 1100 on a personal smart phone. The screen illustration does not present all available features, functions or information that may be presented to the user. The exemplary screen which is used to manage gateway hub options contains application top 1120 which indicates the active screen and basic navigation, a tab menu containing section tabs for: wifi settings 1132 which is used to view and configure wifi related connectivity options, cellular settings 1133 which is used to view and configure cellular related connectivity options, battery status 1134 which displays internal battery related information, alarm signal 1135 which is used to view and configure alarm signal related options, for example whether the output signal 1136 should be enabled, whether signal 1137 should be executed without confirmation, and which activity level 1138 is required for signal to be executed.

FIG. 23 Shows an exemplary view to illustrate a screen within the mobile app 1100 on a personal smart phone. The exemplary screen which is used to create a new alert, includes a condition option group: “if” 1149 which lists activity level required to trigger the alert, and “on” to select the weapon or weapon group that the alert applies to. This is followed by one or more action groups: with “then” 1151 which lists alert communication types, and “to” 1152 which lists individual contacts as well as defined groups of contacts, an actions chain link 1155 which indicates the following action option group is chained to the previous, which would execute upon completion or if any execution issue with the previous action, for example, action (2) “then” 1153 which lists again communication types, and action (2) “to” 1154 which lists again the individual contacts as well as defined groups of contacts who should receive the alert, the chain more actions button 1156 is used to add more action groups as needed. The save button 1157 saves the new alert which becomes active in the system.

With respect to the above description, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system comprising:
a sensor device having on-board power, a processor and memory, wireless communications circuitry, sensing circuitry, preprogrammed to execute a range of functions at least periodically, configured for sending and receiving signals to and from one or more gateway devices;
a gateway device having on-board power, a processor and memory, wireless communications circuitry, preprogrammed to execute a range of functions at least periodically, configured for sending and receiving signals to and from one or more sensor devices, a central service, and local option management through an interactive interface;
a central server in the Internet network having remote communications with gateway devices over an Internet connected communications network, performing functions for device and client requests, providing access to management functions through an interactive interface, including at least account, device and alert option configuration;
wherein the sensor and gateway devices have serial numbers which are registered with the central server, are associated with a particular client account by activation, and the gateway device communicates periodically with the central server, providing sensor information, sending and receiving configuration values, enabling the central server to gather information and perform actions utilizing application programming interfaces APIs that enable database read/write of account, option configurations, user/client authorizations and to communicate with external services.

2. The system of claim 1 wherein the central server stores account, device, sensor, and weapon information along with configuration and alert options, to be made available by either push or by request to clients having authorization.

3. A method for monitoring a weapon or its storage container, comprising the steps of:
(a) attaching into a weapon or its storage container a device having on-board power, a processor and memory, wireless communications circuitry, sensing circuitry, preprogrammed to execute a range of functions at least periodically, configured for sending and receiving signals to and from one or more gateway devices;
(b) communicating by the sensor device via wireless communication to the gateway, sensor values including at least motion, orientation, battery status, and in certain embodiments also GPS coordinates;
(c) execute desired functions when sensor values meet certain criteria at the gateway device, and in some embodiments also relay values to a processing server to execute additional defined functions;
(d) making the sensor activity and results of any gateway function execution available via an interactive interface;
(e) notify at least the associated owner of the sensor by preferred communication options;
